(19) United States
(12) Patent Application Publication
(10) Pub. No.: US 2022/0032589 A1
(43) Pub. Date: Feb. 3, 2022

(54) MULTILAYER FILM

(71) Applicant: Berry Global, Inc., Evansville, IN (US)

(72) Inventors: Michael A. KINNAN, North Canton, OH (US); Brooke D. KITZMILLER, North Canton, OH (US)

(21) Appl. No.: 17/388,212

(22) Filed: Jul. 29, 2021

Related U.S. Application Data
(60) Provisional application No. 63/059,277, filed on Jul. 31, 2020.

(51) Int. Cl. B32B 27/08; B32B 7/02; B32B 27/32; B65D 65/40

(52) U.S. Cl. CPC B32B 27/08; B32B 7/02; B32B 27/32; B65D 65/40; B32B 2555/00; B32B 2250/242; B32B 2270/00; B32B 2553/00; B32B 2250/04

(57) ABSTRACT

A multilayer film comprises an inner layer and an outer layer. The multilayer film can be used to wrap products. The multilayer film is free of tris(nonylphenyl) phosphite (TNPP).

### PRIORITY CLAIM

This application claims priority under 35 U.S.C. § 119(e) to U.S. Provisional Application No. 63/059,277, filed Jul. 31, 2020, which is expressly incorporated by reference herein.

### BACKGROUND

The present disclosure relates to films, and particularly to multilayer films. More particularly, the present disclosure relates to multilayer films for wrapping products.

### SUMMARY

According to the present disclosure, a multilayer film includes an inner layer and an outer layer. The multilayer film may be used to wrap products.

In illustrative embodiments, the multilayer film includes a core layer. In some embodiments, the inner layer, the core layer, the outer layer, or a combination thereof is free of tris(nonylphenyl) phosphite (TNPP).

In illustrative embodiments, the wrapped product may be a nonwoven to be used in a personal hygiene product. In some embodiments, the wrapped product is wood pulp.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

FIG. 1 is a perspective view of a multilayer film wrapping a product; and

FIG. 2 is an illustration of the multilayer film of FIG. 1 showing, from top to bottom, an outer layer, a core layer having a second sublayer and a first sublayer, and an inner layer.

### DETAILED DESCRIPTION

When used in films, tris(nonylphenyl) phosphite (TNPP) may degrade to release nonylphenol. The TNPP and/or the nonylphenol may migrate from a wrapping film to products stored within the film. This migration may occur whether or not the TNPP or degradation products are present in a film layer contacting the product or if in a film layer not directly contacting the product. For certain industries and markets, it may be advantageous for the wrapping film to be free of TNPP. A multilayer film 10 in accordance with the present disclosure may be used to wrap products. In some embodiments, multilayer film 10 is a stretch film. Multilayer film 10 may be free of TNPP.

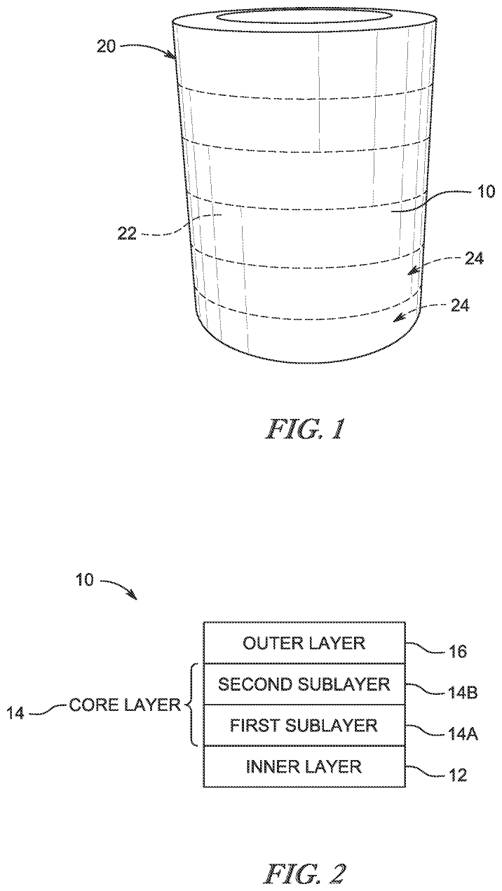

A package 20 is shown in FIG. 1. Package 20 includes product 22 wrapped by multilayer film 10. Illustratively, product 22 is present in rolls 24 of product 22 that are stacked vertically from the floor. In other embodiments, product 22 may be a singular roll.

Multilayer film 10 includes inner layer 12, core layer 14, and outer layer 16, as shown in FIG. 1. Inner layer 12 is configured to contact a product when multilayer film 10 is used to wrap a product. Core layer 14 is located between inner layer 12 and outer layer 16. Outer layer 16 is configured to form the outer surface of a wrapped product. Inner layer 12, core layer 14, and outer layer 16 cooperate to secure products, as suggested in FIG. 1. In some illustrative embodiments, multilayer film 10 includes at least 3, at least 4, or at least 5 layers. In some embodiments, multilayer film 10 is 3 layers, 5 layers, 7 layers, 9 layers, or 11 layers.

The thickness of multilayer film 10 may be about 0.5 mils to about 4 mils. Illustratively, the thickness of multilayer film may be chosen for the product being wrapped by multilayer film 10. In some embodiments, multilayer film 10 is at least about 0.7 mils or at least about 1.5 mils. In some embodiments, multilayer film is about 1.5 mils to about 4 mils or about 1.5 mils to about 3 mils. In some embodiments, multilayer film 10 is about 0.5 mils to about 1.5 mils, about 0.5 mils to about 1.2 mils, or about 0.7 mils to about 1.2 mils.

In some embodiments, multilayer film 10 has a peel cling of at least 10 gm or at least 20 gm. In some embodiments, multilayer film 10 has a peel cling/mil thickness of the film of at least about 4 gm/mil or at least about 10 gm/mil. In some embodiments, multilayer film 10 has a peel cling/mil thickness of the film of at least less than about 30 gm/mil or less than about 20 gm/mil.

In some embodiments, multilayer film 10 is substantially free of trisalkyl phenyl phosphites and/or degradation products thereof. Trisalkyl phenyl phosphites, such as TNPP, may be added by the resin manufacturer or may be residually present from a resin manufacturing process. In illustrative embodiments, inner layer 12, core layer 14, outer layer 16, or a combination thereof is substantially free of trisalkyl phenyl phosphites. For example, inner layer 12, core layer 14, outer layer 16, or a combination thereof is substantially free of TNPP. For another example, inner layer 12, core layer 14, outer layer 16, or a combination thereof is substantially free of the TNPP degradation product nonylphenol.

Inner layer 12 may be about 5% to about 20% by weight of multilayer film 10. In some embodiments, inner layer 12 is about 5% to about 20% or about 5% to about 15% by weight of multilayer film 10. In some embodiments, inner layer 12 is about 10% by weight of multilayer film 10. In illustrative embodiments, inner layer 12 operates as a cling layer for multilayer film 10. In illustrative embodiments, inner layer 12 directly contacts a product.

In illustrative embodiments, inner layer 12 comprises a plastomer. Exemplary plastomers include Dow Affinity KC8852G, available from The Dow Chemical Company. In some embodiments, inner layer 12 consists of or consists essentially of plastomer.

Core layer 14 may include a polyethylene or a blend of polyethylenes. In some embodiments, core layer 14 comprises a linear low density polyethylene (LLDPE) or a blend of LLDPEs. In some embodiments, core layer 14 consists of or consists essentially of LLDPE or a blend of LLDPEs.

Core layer 14 may include a first sublayer 14A and a second sublayer 14B as shown in FIG. 2. First sublayer 14A is located between inner layer 12 and second sublayer 14B. Second sublayer 14B is located between outer layer 16 and first sublayer 14A. In some embodiments, core layer 14 does not include second sublayer 14B. In illustrative embodiments, core layer 14 provides strength and stretch to multilayer film 10. Core layer 14 may be about 35% to about 90% of multilayer film 10.

First sublayer 14A may be about 35% to about 90% by weight of multilayer film 10. In some embodiments, first sublayer 14A is about 35% to about 90% about 45% to about 90%, about 45% to about 80%, or about 55% to about 70% by weight of multilayer film. In some embodiments, first sublayer 14A is about 64% by weight of multilayer film 10. In some embodiments, second sublayer 14B is not present and first sublayer 14A contacts both inner layer 12 and outer layer 16.

First sublayer 14A may comprise a polyolefin or a blend of polyolefins. In some embodiments, first sublayer 14A comprises polyethylene or a blend of polyethylenes. In some embodiments, first sublayer 14A comprises a linear low density polyethylene (LLDPE) or a blend of LLDPEs. In some embodiments, first sublayer 14A comprises at least about 50% of a first LDPE and optionally comprises up to about 50% of a second LLDPE. In some embodiments, first sublayer 14A comprises about 50% to about 100% of a first LLDPE and about 0 to about 50% of a second LLDPE. Illustrative LLDPEs include Dow Elite 5230F and Dow Dowlex 2045G, both available from The Dow Chemical Company. In some embodiments, first sublayer 14A consists of or consists essentially of LLDPE or a blend of LLDPEs.

Second sublayer 14B is optional. If present, second sublayer 14B may be up to about 25% by weight of multilayer film 10. Second sublayer 14B may be about 5% to about 25% about 5% to about 20%, or about 5% to about 15% by weight of multilayer film 10.

Second sublayer 14B may comprise a polyolefin. In some embodiments, second sublayer 14B comprises polyethylene. In some embodiments, second sublayer 14B comprises a linear low density polyethylene (LLDPE). Illustrative LLDPEs include Dow Elite 5230F and Dow Dowlex 2045G, both available from The Dow Chemical Company. In some embodiments, second sublayer 14B consists of or consists essentially of LLDPE.

Illustratively, each layer of multilayer film 10 may comprise an additive or a blend of additives. Illustrative additives include antioxidants, slip agents, or any other material to improve processing or manufacturing of multilayer film 10. Illustrative antioxidants include Irgafos 168 and Weston 706.

Outer layer 16 may be about 5% to about 25% by weight of multilayer film 10. In some embodiments, inner layer 12 is about 5% to about 25%, about 5% to about 20%, or about 10% to about 20% by weight of multilayer film 10. In illustrative embodiments, outer layer 16 operates as a release layer for multilayer film 10.

In illustrative embodiments, outer layer 16 comprises a polyolefin. The polyolefin may be polyethylene. Exemplary polyethylenes includes a low density polyethylene (LDPE) such as Dow 501i, available from The Dow Chemical Company. In some embodiments, outer layer 16 consists of or consists essentially of polyethylene. In some embodiments, outer layer 16 consists of or consists essentially of LDPE.

Multilayer film 10 may be used to wrap or secure a product. For example, in some embodiments multilayer film 10 is a stretch film and wraps around a product. The product wrapped by multilayer film 10 may be suitable for transportation, for example shipping. Illustratively, the product may be a personal hygiene product or the product may be used in a personal care product or a hygiene product. For example, the product may be bulk nonwoven that is used to form a personal care product or a hygiene product. In another example, the product may be pulp that is used to form a personal care product or a hygiene product. It may be desirable that the product is free of TNPP or degradation products thereof, such as nonylphenol after removing multilayer film 10.

### Example 1

Film

A three mil film was prepared according to Table 1.

TABLE 1
Film Composition

| | | | Resin wt % |
|---|---|---|---|
| | Layer | | within |
| Layer | wt % | Resin | layer |
| Outer Layer | 15% | Dow 501i (LDPE) | 100% |
| Second | 11% | Dow Elite 5230F (LLDPE) | 100% |
| Sublayer | | | |
| First | 64% | Dow Elite 5230F (LLDPE) | 65% |
| Sublayer | | Dow Dowlex 2045G (LLDPE) | 35% |
| Inner Layer | 10% | Dow Affinity KC8852G | 100% |
| | | (Plastomer) | |

Comparative Multilayer Film

A three mil comparative multilayer film was made according to Table 2. At least one of the layers of the film in Table 2 contain TNPP.

TABLE 2
Comparative Film Composition

| | | | Resin wt % |
|---|---|---|---|
| | Layer | | within |
| Layer | wt % | Resin | layer |
| Outer Layer | 15% | LDPE | 50% |
| | | Narrow molecular weight | 50% |
| | | distribution LLDPE | |
| Second | 10% | Comparable to Example 1 | 100% |
| Sublayer | | | |
| First | 65% | Comparable to Example 1 | 100% |
| Sublayer | | | |
| Inner Layer | 10% | Plastomer comparable to | 55% |
| | | Example 1 | |
| | | Narrow molecular weight | 45% |
| | | distribution LLDPE | |

A 3 mil film according to Table 1 and a 3 mil film according to Table 2 were analyzed. The resulting properties of these two film shown below in Table 3.

TABLE 3
Film Properties

| | Test Method | Table 2 Film | | Table 1 Film | |
|---|---|---|---|---|---|
| Peel Cling | | 9.5 | gm | 34.1 | gm |
| Stress @ Peak MD | ASTM D882 | 5873 | psi | 5200 | psi |
| Strain @ Peak MD | | 833% | | 772% | |
| Stress @ Break MD | | 5873 | psi | 5200 | psi |
| Strain @ Break MD | | 833% | | 772% | |
| TEA MD | | 129 | in · lbf | 114 | in · lbf |
| Stress @ Peak TD | | 5090 | psi | 5,399 | psi |
| Strain @ Peak TD | | 843% | | 890% | |
| Stress @ Break TD | | 5090 | psi | 5,399 | psi |
| Strain @ Break TD | | 843% | | 890% | |
| TEA TD | | 113 | in · lbf | 127 | in · lbf |
| Elmendorf Tear MD | ASTM D1922 | 890 | gf | 833 | gf |
| Elmendorf Tear TD | | 1229 | gf | 1445 | gf |
| Dart Drop (26″) | ASTM D1709 | 418 | g | 419 | g |
| Puncture-1/8″ (Kraft) | ASTM D7192 | 1,920 | gf | 1,851 | gf |

1. A package comprising
a product, and
a multilayer film wrapped around the product, the multilayer film including an inner layer arranged to contact the product and an outer layer spaced apart from the product and arranged to locate the inner layer therebetween,
wherein each layer of the multilayer film is free of tris(nonylphenyl) phosphite (TNPP).

2. The package of claim 1, wherein the outer layer comprises low density polyethylene (LDPE).

3. The package of claim 2, wherein the inner layer comprises a plastomer.

4. The package of claim 3, wherein the multilayer film includes a core layer comprising linear low density polyethylene (LLDPE).

5. The package of claim 4, wherein the core layer includes a first sublayer and a second sublayer, and the first sublayer is located between the second sublayer and the inner layer.

6. The package of claim 5, wherein the second sublayer of the core layer comprises a first LLDPE and a second LLDPE that is different from the first LLDPE.

7. The package of claim 4, wherein the core layer is about 35-90% by weight of the multilayer film.

8. The package of claim 1, wherein the product is a nonwoven.

9. The package of claim 8, wherein the nonwoven is for a personal hygiene product.

10. The package of claim 9, wherein the multilayer film has a thickness of about 0.7 mils to about 1.2 mils.

11. The package of claim 1, wherein the product is pulp.

12. The package of claim 11, wherein the pulp is for a personal hygiene product.

13. The package of claim 12, wherein the multilayer film has a thickness of about 1.5 mils to about 4 mils.

14. The package of claim 1, wherein the multilayer film directly contacts the product and TNPP is not transferred from the multilayer film to the product.

15. A multilayer film comprising
an inner layer configured to contact a product,
an outer layer spaced apart from the inner layer, and
a core layer extending between and interconnecting the inner layer and the outer layer,
wherein each layer of the multilayer film is free of tris(nonylphenyl) phosphite (TNPP).

16. The multilayer film of claim 15, wherein the outer layer comprises low density polyethylene (LDPE).

17. The multilayer film of claim 16, wherein the inner layer comprises a plastomer.

18. The multilayer film of claim 17, wherein the multilayer film has a thickness of at least 0.7 mils.

19. The multilayer film of claim 18, wherein the core layer comprises linear low density polyethylene (LLDPE).

20. The multilayer film of claim 18, wherein the core layer consists essentially of linear low density polyethylene (LLDPE).
